(19) United States
(12) Patent Application Publication
(10) Pub. No.: US 2003/0104217 A1
(43) Pub. Date: Jun. 5, 2003

(54) Polyurethane powder coating compositions

(75) Inventors: Andreas Wenning, Nottuln (DE); Giselher Franzmann, Witten (DE)

Correspondence Address: OBLON, SPIVAK, MCCLELLAND, MAIER & NEUSTADT, P.C., FOURTH FLOOR, 1755 JEFFERSON DAVIS HIGHWAY, ARLINGTON, VA, 22202, US

(73) Assignee: DEGUSSA AG, Duesseldorf (DE)

(21) Appl. No.: 10/307,474

(22) Filed: Dec. 2, 2002

(30) Foreign Application Priority Data
Dec. 4, 2001 (DE) 101 59 488.7

(51) Int. Cl. B32B 27/00

(52) U.S. Cl. 428/423.1

(57) ABSTRACT

Polyurethane powder coating compositions based on semicrystalline polyesters, amorphous polyesters, and blocked polyisocyanates can be used as polyurethane powder coating materials and powder coil coating materials.

### BACKGROUND OF THE INVENTION

1. Field of the Invention

The present invention relates to a polyurethane (PU) powder coating composition based on a semicrystalline polyester, amorphous polyester, and a blocked polyisocyanate and to its use for a polyurethane powder coating material.

2. Discussion of the Background

Thermosetting powder coating compositions are used intensively for producing crosslinked coatings on a wide variety of substrates. In comparison with thermoplastic compositions, thermosetting coating materials generally are harder, are more resistant to solvents and detergents, possess better adhesion to metallic substrates, and do not soften on exposure to elevated temperatures.

Since 1970, thermosetting compositions in powder form have been known. They are obtained by reacting a hydroxyl-containing resin with a blocked polyisocyanate. Among the blocked polyisocyanates, isophorone diisocyanate adducts blocked with ε-caprolactam have become established as PU powder coating hardeners. The PU powders prepared using these hardeners have superior weathering stability and color stability at elevated temperature and consequently are used to coat a wide variety of metal objects. Powders of this kind are described, for example, in DE 27 35 497. Using these powders, shaped metal pieces are coated individually (postcoated metals).

Coil coating, on the other hand, is a method of coating metal strips at speeds from 60 to 200 m/min. Sheet metal, preferably steel or aluminum, is cleaned and coated with a paint. The sheet metal is then sent on for further processing, where it receives its actual shape. The major areas of application are trapezoidal profiles coated with weather-resistant paints, for facings and roofs and also doors, window frames, gates, guttering, and blinds, for example. For the interior sector, coil-coated metal sheets are used principally for dividing walls and for ceiling elements. Other areas of use, however, include steel furniture, shelving, shop fitting, and appliance panels. Lamps and lighting form a further important application segment. There is also a broad range of applications in the automotive sector. Truck bodies and exterior automotive components are frequently manufactured from precoated materials.

For coating the substrate used it is common to carry out a pretreatment. As the first coating film, a primer is applied in a film thickness of from 5 to 10 μm to what will subsequently be the visible side. After a first pass through the dryer, the actual topcoat is then applied, which after drying has a film thickness of about 20 μm. In some cases this surface is further laminated with a temporary protective film in the hot state. The purpose of this is to protect it against mechanical damage. In parallel with the coating of the visible sides, the reverse sides are also coated. The primers used include, for example, polyester resins. For coil-coated facings and roofs in a corrosive industrial climate, the primers employed are epoxide-containing systems. Use is made primarily of liquid paints in innumerable colors as topcoat material. Depending on the field of use, polyester, polyurethane or PVDF topcoat materials, for example, are employed. The normal film thicknesses of the topcoats are about 20 μm.

In addition to the liquid primers and topcoat materials use is also made of powder coating materials for coating metal strips in the coil coating process. Powder coating materials have the great advantage over their liquid counterparts that they are solvent free and hence more environmentally friendly. However, their share among coil coating systems has to date been relatively small.

One of the reasons for this was the high film thicknesses of the powder coatings, at more than 40 μm. This leads to optical defects, since the surface is no longer entirely pore free. This disadvantage was eliminated by WO 97/47400, which describes a method of coating metal strips with which powder coated thicknesses of less than 20 μm can be achieved.

A second disadvantage for comparison to liquid coating materials was the extremely low strip speed when applying the powder coating material. Using electrostatic spray guns, metal strips can be coated with powder coating material only at plant speeds of not more than 20 m/min. As a result of the MSC Powder Cloud™ technology, described for example by F. D. Graziano, XXIIIrd International Conference in Organic Coatings, Athens, 1997, pages 139-150 or by M. Kretschmer, 6th DFO-Tagung Pulverlack-Praxis, Dresden, 2000, pages 95-100, it is now possible to realize strip speeds of from 60 to 100 m/min.

PU powder coating materials are known, inter alia, for their high weathering stability, excellent leveling, and good flexibility. For use in coil coating materials, however, the flexibility of the systems known to date is often insufficient. A search is therefore on for new PU powder coating materials which satisfy the extreme flexibility requirements of coil coating materials. Finding such materials would also remove the third critical disadvantage relative to conventional liquid coating materials.

U.S. Pat. No. 4,387,214 and U.S. Pat. No. 4,442,270 describe the use of semicrystalline polyesters of terephthalic acid and hexane-1,6-diol in polyurethane powder coating materials as primers or topcoats for automobiles. These coating materials are very flexible. The surfaces, however, are extremely soft and therefore of low mar resistance. High gloss clearcoats cannot be produced using this powder coating material, since the crystalline polyester is incompatible with the amorphous isocyanate component. Clouding occurs in the coating film, reducing the gloss. Their use in powder coil coating materials is also not possible, since under the extreme curing conditions—curing at high temperatures with subsequent shock cooling—cracks are formed in the films.

U.S. Pat. No. 4,859,760 describes a powder coating composition comprising a mixture of amorphous and semicrystalline polyesterpolyols which are crosslinked using blocked polyisocyanates. The semicrystalline polyesters possess a glass transition temperature of from −10 to +50° C. They contain terephthalic acid. Accordingly, the weathering stability of the powder coating materials for demanding outdoor applications such as automobile finishing or architectural facing, for example, is inadequate.

WO 94/02552 describes semicrystalline polyesters based on hexane-1,6-diol and 1,12-dodecanedioic acid as plasticizers for powder coating materials. The addition of the semicrystalline polyester improves the leveling, flexibility, and deformability of the powder coatings. Use of the powder coating materials for coil coating is not described. In the case where polyisocyanate crosslinkers containing uretdione groups are used, however, high fractions of semicrystalline polyester are needed in order to achieve the requisite high flexibility, particularly for powder coil coating applications. As a result, the gloss of the coatings is reduced. Moreover, the amorphous polyester contains predominantly terephthalic acid as its dicarboxylic acid. The consequence is a reduction in the weathering stability of the powder coatings.

WO 95/01407 describes thermosetting powder coating compositions comprising an amorphous polyester, composed of cyclohexanedicarboxylic acid and a cycloaliphatic diol, a semicrystalline polyester, composed of cyclohexanedicarboxylic acid and a linear diol, and a suitable crosslinker. Features of these powder coating materials include their high UV resistance and very good flexibility. A disadvantage is the high price of the cyclohexanedicarboxylic acid raw material. Use of the powder coating compositions for coating by the coil coating process is not described.

### SUMMARY OF THE INVENTION

It is therefore an object of the present invention to find inexpensive, highly flexible powder coating compositions with a high level of weather stability which can be used both for PU powder coating materials and for PU powder coil coating materials.

This and other objects have been achieved by the present invention the first embodiment which includes a polyurethane powder coating composition, comprising:

A) from 5 to 80% by weight of at least one (semi)crystalline polyester having a hydroxyl number of from 5 to 100 mg KOH/g, a melting point from 50 to 130° C. and a glass transition temperature of <−10° C.;

wherein said (semi)crystalline polyester comprises

a) i) from 85 to 100 mol % of succinic acid; or

a) ii) from 85 to 100 mol % of adipic acid; or

a) iii) from 85 to 100 mol % of sebacic acid; or

a) iv) from 85 to 100 mol % of dodecanedioic acid; and

a) v) from 15 to 0 mol % of at least one second aliphatic, cycloaliphatic or aromatic dicarboxylic acid; and

b) i) from 80 to 100 mol % of monoethylene glycol; or

b) ii) from 80 to 100 mol % of butane-1,4-diol; or

b) iii) from 80 to 100 mol % of hexane-1,6-diol; and

b) iv) from 20 to 0 mol % of at least one further aliphatic or cycloaliphatic, linear or branched polyol; and

B) from 10 to 80% by weight of at least one amorphous polyester having a hydroxyl number of from 15 to 200 mg KOH/g, a melting point from ≧70° C. to ≦120° C., and a glass transition temperature of >40° C.;

wherein said amorphous polyester comprises

c) i) from 40 to 100 mol % of isophthalic acid; and

c) ii) from 60 to 0 mol % of at least one further aliphatic, cycloaliphatic or aromatic dicarboxylic or polycarboxylic acid; and

d) i) from 80 to 100 mol % of at least one linear, aliphatic or cycloaliphatic diol; and

d) ii) from 20 to 0 mol % of at least one branched, aliphatic or cycloaliphatic polyol; and

C) from 5 to 30% by weight of at least one isocyanate component comprising a) an urethane group or b) an urethane group and an isocyanurate group;

wherein said isocyanate component is partly or totally blocked with a blocking agent.

### DETAILED DESCRIPTION OF THE INVENTION

Surprisingly it has been found that certain polyisocyanate crosslinkers containing urethane groups or urethane groups and isocyanurate groups, in combination with amorphous polyesters containing predominantly isophthalic acid and certain (semi)crystalline polyesters with low glass transition temperatures can be processed to binders that are suitable for coating any substrates, especially metallic substrates, both as conventional powder coating materials and by the coil coating process.

The invention accordingly provides PU powder coating compositions substantially comprising

A) from 5 to 80% by weight of at least one (semi)crystalline polyester having a hydroxyl number of from 5 to 100 mg KOH/g, a melting point from 50 to 130° C. and a glass transition temperature of <−10° C. comprising p2 a) i) from 85 to 100 mol % of succinic acid; or

a) ii) from 85 to 100 mol % of adipic acid; or

a) iii) from 85 to 100 mol % of sebacic acid; or

a) iv) from 85 to 100 mol % of dodecanedioic acid; and

a) v) from 15 to 0 mol % of at least one further aliphatic, cycloaliphatic or aromatic dicarboxylic acid; and

b) i) from 80 to 100 mol % of monoethylene glycol; or

b) ii) from 80 to 100 mol % of butane-1,4-diol; or

b) iii) from 80 to 100 mol % of hexane-1,6-diol; and

b) iv) from 20 to 0 mol % of at least one further aliphatic or cycloaliphatic, linear or branched polyol; and

B) from 10 to 80% by weight of at least one amorphous polyester having a hydroxyl number of from 15 to 200 mg KOH/g, a melting point ≧70° C. to ≦120° C., and a glass transition temperature of >40° C. comprising

c) i) from 40 to 100 mol % of isophthalic acid; and

c) ii) from 60 to 0 mol % of at least one further aliphatic, cycloaliphatic or aromatic dicarboxylic or polycarboxylic acid; and

d) i) from 80 to 100 mol % of at least one linear, aliphatic or cycloaliphatic diol; and

d) ii) from 20 to 0 mol % of at least one branched, aliphatic or cycloaliphatic polyol; and

C) from 5 to 30% by weight of at least one isocyanate component containing a) urethane groups or b) urethane groups and isocyanurate groups and blocked partly or totally with a blocking agent, and

D) optionally, customary auxiliaries and adjuvants.

Polyester A) is at least one semicrystalline or crystalline polyester having a hydroxyl number of from 5 to 100 mg KOH/g, a melting point from 50 to 130° C., and a glass transition temperature of <−10° C. The hydroxyl number includes all values and subvalues therebetween, especially including 10, 20, 30, 40, 50, 60, 70, 80 and 90 mg/KOH/g. The melting point includes all values and subvalues therebetween, especially including 60, 70, 80, 90, 100, 110 and 120° C. The polyesters are based on linear dicarboxylic acids and aliphatic or cycloaliphatic, linear or branched polyols.

Dicarboxylic acids used are succinic acid or adipic acid or sebacic acid or dodecanedioic acid in amounts of at least 85 mol %, preferably at least 90 mol %, most preferably at least 95 mol %, based on the total amount of all carboxylic acids. In the present invention the expression dicarboxylic acid always includes the esters, anhydrides or acid chlorides thereof, which of course may likewise be used. In much lower fractions of up to a maximum of 15 mol % it is also possible, if desired, to use other aliphatic, cycloaliphatic or aromatic dicarboxylic acids. Examples of such dicarboxylic acids are glutaric acid, azelaic acid, 1,4-, 1,3- or 1,2-cyclohexanedicarboxylic acid, terephthalic acid or isophthalic acid.

As the polyol component for the (semi)crystalline polyesters, use is made of monoethylene glycol or butane-1,4-diol or hexane-1,6-diol in amounts of at least 80 mol %, preferably at least 85 mol % and most preferably at least 90 mol %, based on the total amount of all polyols. In amounts of not more than 20 mol % it is possible, if desired, to use other aliphatic or cycloaliphatic, linear or branched polyols. Examples of such polyols are diethylene glycol, neopentyl glycol hydroxypivalate, neopentyl glycol, cyclohexanedimethanol, pentane-1,5-diol, pentane-1,2-diol, nonane-1,9-diol, trimethylolpropane, glycerol or pentaerythritol.

Polyester B) is at least one amorphous polyester. The amorphous polyesters are based on linear or branched polycarboxylic acids and aliphatic or cycloaliphatic, linear or branched polyols. As the dicarboxylic acid isophthalic acid is used in an amount of at least 40 mol %, preferably at least 50 mol % and most preferably at least 60 mol %, based on the total amount of all carboxylic acids. In fractions up to a maximum of 60 mol % it is possible, if desired, to use other aliphatic, cycloaliphatic or aromatic dicarboxylic or polycarboxylic acids. Examples of such carboxylic acids are phthalic acid, adipic acid, azelaic acid, sebacic acid, dodecanedioic acid, trimellitic acid, hexahydroterephthalic acid, hexahydrophthalic acid, succinic acid or 1,4-cyclohexanedicarboxylic acid. As the polyol component for the amorphous polyesters, use is made of linear, aliphatic or cycloaliphatic diols in amounts of at least 80 mol %, preferably at least 85 mol % and most preferably at least 90 mol %, based on the total amount of all polyols used. Preferred examples of such diols are monoethylene glycol, diethylene glycol, neopentyl glycol hydroxypivalate, neopentyl glycol, cyclohexanedimethanol, butane-1,4-diol, pentane-1,5-diol, pentane-1,2-diol, hexane-1,6-diol or nonane-1,9-diol. In amounts of not more than 20 mol % it is possible, if desired, to use branched, aliphatic or cycloaliphatic polyols. Preferred examples of such polyols are trimethylolpropane, glycerol or pentaerythritol.

The amorphous polyesters B) to be used, containing hydroxyl groups and isophthalic acid, have an OH functionality of from 2.0 to 5, preferably from 2.0 to 4.2, a number-average molecular weight of from 800 to 8 000, preferably from 1 200 to 5 000, an OH number of from 15 to 200 mg KOH/g, preferably from 20 to 100 mg KOH/g, a melting point from ≧70° C. to ≦120° C., preferably from ≧75 to ≦100° C., and a glass transition temperature of >40° C. The OH functionality includes all values and subvalues therebetween, especially including 2.5, 3.5, 4 and 4.5. The number average molecular weight includes all values and subvalues therebetween, especially including 1000, 2000, 3000, 4000, 5000, 6000, 7000 and 8000. The OH number includes all values and subvalues therebetween, especially including 20, 40, 60, 80, 100, 120, 140, 160 and 180 mg KOH/g. The melting point includes all values and subvalues therebetween, especially including 80, 90, 100 and 110° C.

It is essential that the amorphous polyester B) contains isophthalic acid or its esters or acid chloride in an amount of at least 40 mol %, preferably at least 50 mol % and most preferably at least 60 mol %.

The (semi)crystalline and amorphous polyesters may be obtained conventionally by condensing polyols and polycarboxylic acids or their esters, anhydrides or acid chlorides in the melt or using an azeotropic procedure in an inert gas atmosphere at temperatures from 100 to 260° C., preferably from 130 to 220° C., as described, for example, in Methoden der Organischen Chemie (Houben-Weyl), vol. 14/2, 1-5, 21-23, 40-44, Georg Thieme Verlag, Stuttgart, 1963, in C. R. Martens, Alkyd Resins, 51-59, Reinhold Plastics Appl. Series, Reinhold Publishing Comp., New York, 1961, or in DE-As 27 35 497 and 30 04 903. The temperature of the azeotropic procedure includes all values and subvalues therebetween, especially including 110, 120, 130, 140, 150, 160, 170, 180, 190, 200, 210, 220, 230, 240 and 250° C.

Isocyanate component C) comprises isocyanates which contain urethane groups or urethane and isocyanurate groups and whose isocyanate groups have been partly or totally blocked with a blocking agent. These isocyanates are known in principle and described in numerous patents such as, for example, DE 27 12 931, 29 29 224, 22 00 342, DE 196 34 054, EP 0 432 257, U.S. Pat. No. 3,857,818, EP 0 159 117, EP 0 713 871, DE 28 12 252, DE 100 33 097, DE 196 26 886, DE 197 30 670, WO 99/06461 or DE 34 34 881.

Isocyanates used for preparing the isocyanate component C) are diisocyanates of aliphatic and (cyclo)aliphatic and/or cycloaliphatic structure. Diisocyanates of this kind are described, for example, in Houben-Weyl, Methoden der organischen Chemie, volume 14/2, p. 61 ff. and J. Liebigs Annalen der Chemie, volume 562, pp. 75-136. Preference is generally given to using the aliphatic diisocyanates which are readily available industrially, such as hexamethylene diisocyanate, 2-methylpentamethylene 1,5-diisocyanate, 2-ethyltetramethylene 1,4-diisocyanate or trimethylhexamethylene 1,6-diisocyanate, especially the 2,2,4 isomer and the 2,4,4 isomer and technical-grade mixtures of both isomers, the (cyclo)aliphatic diisocyanates such as isophorone diisocyanate, and the cycloaliphatic diisocyanates such as 4,4′-diisocyanatodicyclohexylmethane or norbornane diisocyanate. By (cyclo)aliphatic diisocyanates the skilled worker adequately understands NCO groups attached aliphatically and cyclically at the same time, as is the case with isophorone diisocyanate, for example. Contrastingly, cycloaliphatic diisocyanates are understood as those which contain only NCO groups attached directly to the cycloaliphatic ring.

For preparing the isocyanate component C) (containing urethane groups), in a first stage the diisocyanate is reacted with the polyol. In this reaction, the diisocyanate is introduced and heated to from 100 to 120° C. and then the polyol is metered in with thorough stirring over the course of from 2 to 3 hours, under nitrogen and in the absence of moisture, in such a way that at least 2 and not more than 8, preferably from 4 to 6, equivalents of NCO in the diisocyanate are reacted per OH equivalent of the polyol. The reaction temperature for the reaction of the diisocyanate with polyol includes all values and subvalues therebetween, especially including 102, 104, 106, 108, 110, 112, 114, 116 and 118° C.

The time for metering in the polyol includes all values and subvalues therebetween, especially including 2 h 10 min, 2 h 20 min, 2 h 30 min, 2 h 40 min, and 2 h 50 min.

The reaction may be accelerated by adding a conventional urethanization catalyst, examples being organotin compounds and also certain tertiary amines, such as triethylenediamine, in an amount from 0.01 to 1% by weight, preferably from 0.05 to 0.15% by weight, based on the reaction mixture. The amount of the urethanization catalyst includes all values and subvalues therebetween, especially including 0.05, 0.1, 0.2, 0.3, 0.4, 0.5, 0.6, 0.7, 0.8 and 0.9% by weight.

In the second stage the NCO groups are then blocked with a blocking agent. The reaction may be conducted without solvent or else in the presence of suitable (inert) solvents. It is preferred, however, to operate without solvent. In this reaction the blocking agent is added in portions to the polyol-diisocyanate adduct at from about 100 to 130° C. in such a way that the temperature does not rise above 140° C. The addition temperature includes all values and subvalues therebetween, especially including 105, 110, 115, 120 and 125° C.

After the blocking agent has been added, the reaction is completed by heating the reaction mixture at 130° C. for from about 1 to 2 h. The heating time includes all values and subvalues therebetween, especially including 1 h 10 min, 1 h 20 min, 1 h 30 min, 1 h 40 min and 1 h 50 min.

The blocking agent is added in amounts such that from 0.7 to 1.1 mol of blocking agent, preferably 1 mol, is reacted per NCO equivalent of the urethanized diisocyanate.

Suitable polyols for reaction with the diisocyanate in the first stage of the preparation process are all polyols known in PU chemistry, such as ethylene glycol, propane-1,3-diol, butane-1,4-diol, pentane-1,5-diol, 3-methylpentane-1,5-diol, hexane-1,6-diol, 2,2,4 (2,4,4)-trimethylhexane-1,6-diol, 1,4-di(hydroxymethyl)cyclohexane, diethylene glycol, triethylene glycol, diethanolmethylamine, neopentyl glycol, triethanolamine, trimethylolpropane, trimethylolethane, glycerol, and pentaerythritol, for example.

One preferred embodiment of the preparation process involves preparing the blocked diisocyanate adducts in reverse order; that is, the first stage comprises partial reaction of the diisocyanate with the blocking agent, and the second stage the reaction with the polyol.

The diisocyanate particularly preferred for preparing the isocyanate component C) containing urethane groups is isophorone diisocyanate.

The abovementioned diisocyanates are also used for preparing the trimers. The trimers are prepared conventionally in accordance with GB-B 13 91 066 or DE-Cs 23 25 826, 26 44 684 or 29 16 201. The process products comprise isocyanato isocyanurate with higher oligomers where appropriate. They have an NCO content of from 10 to 22% by weight.

The NCO content includes all values and subvalues therebetween, especially including 12, 14, 16, 18 and 20% by weight.

The ratio of the urethane groups to the isocyanurate groups in the isocyanate component C) containing urethane groups and isocyanurate groups may be set arbitrarily.

Any blocking agent may be used for blocking the isocyanate groups of the isocyanate component C). By way of example it is possible to use phenols such as phenol and p-chlorophenol, alcohols such as benzyl alcohol, oximes such as acetone oxime, methyl ethyl ketoxime, cyclopentanone oxime, cyclohexanone oxime, methyl isobutyl ketoxime, methyl tert-butyl ketoxime, diisopropyl ketoxime, diisobutyl ketoxime or acetophenone oxime, N-hydroxy compounds such as N-hydroxysuccinimide or hydroxypyridines, lactams such as ε-caprolactam, CH-acidic compounds such as ethyl acetoacetate or malonates, amines such as diisopropylamine, heterocyclic compounds having at least one heteroatom such as mercaptans, piperidines, piperazines, pyrazoles, imidazoles, triazoles, and tetrazoles, α-hydroxybenzoic esters such as glycolates or hydroxamic esters such as benzyl methacrylohydroxamate.

Particularly preferred blocking agents are ε-caprolactam, acetone oxime, methyl ethyl ketoxime, acetophenone oxime, diisopropylamine, 3,5-dimethyl-pyrazole, 1,2,4-triazole, butyl glycolate, benzyl methacrylohydroxamate or methyl p-hydroxybenzoate.

It is of course also possible to use mixtures of these blocking agents.

The blocking reaction is conducted generally by introducing the isocyanate component as initial charge and adding the blocking agent in portions. The reaction may be conducted without solvent or else in the presence of suitable (inert) solvents. It is preferred, however, to operate without solvent. The isocyanate component is heated to 90-130° C. The temperature includes all values and subvalues therebetween, especially including 100, 110 and 120° C.

At this temperature, the blocking agent is added conventionally. After the blocking agent has been added, the reaction is completed by heating the reaction mixture at 120° C. for from about 1 to 2 h. The blocking agent is added in amounts such that from 0.5 to 1.1 mol of blocking agent, preferably from 0.8 to 1 mol, with particular preference 1 mol, is reacted per NCO equivalent of the isocyanate component. The isocyanate polyaddition reaction may be accelerated by adding the catalysts customary in polyurethane chemistry, such as organotin, organozinc or amine compounds, in an amount of from 0.01 to 1% by weight, based on the overall mixture. The amount of catalyst includes all values and subvalues therebetween, especially including 0.05, 0.1, 0.2, 0.3, 0.4, 0.5, 0.6, 0.7, 0.8 and 0.9% by weight.

The solvent-free blocking reaction may also be conducted continuously in a static mixer or, advantageously, in a multiscrew extruder, particularly in a twin-screw extruder.

The overall NCO content of the blocked isocyanate component C) is from 8 to 20% by weight, preferably from 9 to 17% by weight. The NCO content includes all values and subvalues therebetween, especially including 10, 12, 14, 16 and 18% by weight.

The proportion in which hydroxyl-containing (semi)crystalline polyesters, amorphous polyesters containing hydroxyl groups and isophthalic acid, and blocked isocyanate components are mixed is generally chosen so that there are from 0.6 to 1.2, preferably from 0.8 to 1.1, with very particular preference 1.0, blocked NCO group(s) per OH group.

As auxiliaries and adjuvants D) it is possible, for example, to use catalysts, pigments, fillers, dyes, leveling agents, e.g., silicone oil and liquid acrylate resins, light stabilizers, heat stabilizers, antioxidants, gloss enhancers or effect additives.

The invention likewise provides a process for preparing PU powder coating compositions substantially comprising

A) from 5 to 80% by weight of at least one (semi)crystalline polyester having a hydroxyl number of from 5 to 100 mg KOH/g, a melting point from 50 to 130° C. and a glass transition temperature of <−10° C. comprising

a) i) from 85 to 100 mol % of succinic acid; or

a) ii) from 85 to 100 mol % of adipic acid; or

a) iii) from 85 to 100 mol % of sebacic acid; or

a) iv) from 85 to 100 mol % of dodecanedioic acid; and

a) v) from 15 to 0 mol % of at least one further aliphatic, cycloaliphatic or aromatic dicarboxylic acid; and

b) i) from 80 to 100 mol % of monoethylene glycol; or

b) ii) from 80 to 100 mol % of butane-1,4-diol; or

b) iii) from 80 to 100 mol % of hexane-1,6-diol; and

b) iv) from 20 to 0 mol % of at least one further aliphatic or cycloaliphatic, linear or branched polyol; and

B) from 10 to 80% by weight of at least one amorphous polyester having a hydroxyl number of from 15 to 200 mg KOH/g, a melting point from ≧70° C. to ≦120° C., and a glass transition temperature of >40° C. comprising

c) i) from 40 to 100 mol % of isophthalic acid; and

c) ii) from 60 to 0 mol % of at least one further aliphatic, cycloaliphatic or aromatic dicarboxylic or polycarboxylic acid; and

d) i) from 80 to 100 mol % of at least one linear, aliphatic or cycloaliphatic diol; and

d) ii) from 20 to 0 mol % of at least one branched, aliphatic or cycloaliphatic polyol; and

C) from 5 to 30% by weight of at least one isocyanate component containing urethane groups or urethane groups and isocyanurate groups and blocked partly or totally with a blocking agent; and

D) if desired, auxiliaries and adjuvants; and

prepared in heatable apparatus at an upper temperature limit of between 130 and 140° C.

For the preparation of powder coating materials, the blocked isocyanate component C) is mixed with the hydroxyl-containing, (semi)crystalline polyester A), the amorphous polyester B) containing hydroxyl groups and isophthalic acid, and, where appropriate, customary auxiliaries and adjuvants D). Components A), B), C), and D) are homogenized in the melt. This can be done in suitable equipment, e.g., in heatable compounders, and is preferably achieved by extrusion, during which temperature limits of 130 to 140° C. ought not to be exceeded. The temperature includes all values and subvalues therebetween, especially including 132, 134, 136 and 138° C. After cooling to room temperature and appropriate comminution, the homogenized extrudate is ground to give the ready-to-spray powder.

The invention further provides for the use of compositions substantially comprising

A) from 5 to 80% by weight of at least one (semi)crystalline polyester having a hydroxyl number of from 5 to 100 mg KOH/g, a melting point from 50 to 130° C. and a glass transition temperature of <−10° C. comprising

a) i) from 85 to 100 mol % of succinic acid; or

a) ii) from 85 to 100 mol % of adipic acid; or

a) iii) from 85 to 100 mol % of sebacic acid; or

a) iv) from 85 to 100 mol % of dodecanedioic acid; and

a) v) from 15 to 0 mol % of at least one further aliphatic, cycloaliphatic or aromatic dicarboxylic acid; and

b) i) from 80 to 100 mol % of monoethylene glycol; or

b) ii) from 80 to 100 mol % of butane-1,4-diol; or

b) iii) from 80 to 100 mol % of hexane-1,6-diol; and

b) iv) from 20 to 0 mol % of at least one further aliphatic or cycloaliphatic, linear or branched polyol; and

B) from 10 to 80% by weight of at least one amorphous polyester having a hydroxyl number of from 15 to 200 mg KOH/g, a melting point from ≧70° C. to ≦120° C., and a glass transition temperature of >40° C. comprising

c) i) from 40 to 100 mol % of isophthalic acid; and

c) ii) from 60 to 0 mol % of at least one further aliphatic, cycloaliphatic or aromatic dicarboxylic or polycarboxylic acid; and

d) i) from 80 to 100 mol % of at least one linear, aliphatic or cycloaliphatic diol; and

d) ii) from 20 to 0 mol % of at least one branched, aliphatic or cycloaliphatic polyol; and

C) from 5 to 30% by weight of at least one isocyanate component containing urethane groups or urethane groups and isocyanurate groups and blocked partly or totally with a blocking agent; and

D) if desired, auxiliaries and adjuvants;

for preparing powder coating materials and powder coil coating materials.

With the coating composition of the invention it is possible to produce extremely flexible, weathering-resistant coatings, in particular by the coil coating process.

The invention further provides a process for coating metal strips by the coil coating process using PU powder coating compositions substantially comprising

A) from 5 to 80% by weight of at least one (semi)crystalline polyester having a hydroxyl number of from 5 to 100 mg KOH/g, a melting point from 50 to 130° C. and a glass transition temperature of <−10° C. comprising

a) i) from 85 to 100 mol % of succinic acid; or

a) ii) from 85 to 100 mol % of adipic acid; or

a) iii) from 85 to 100 mol % of sebacic acid; or

a) iv) from 85 to 100 mol % of dodecanedioic acid; and

a) v) from 15 to 0 mol % of at least one further aliphatic, cycloaliphatic or aromatic dicarboxylic acid; and

b) i) from 80 to 100 mol % of monoethylene glycol; or

b) ii) from 80 to 100 mol % of butane-1,4-diol; or

b) iii) from 80 to 100 mol % of hexane-1,6-diol; and

b) iv) from 20 to 0 mol % of at least one further aliphatic or cycloaliphatic, linear or branched polyol; and

B) from 10 to 80% by weight of at least one amorphous polyester having a hydroxyl number of from 15 to 200 mg KOH/g, a melting point from ≧70° C. to ≦120° C., and a glass transition temperature of >40° C. comprising

c) i) from 40 to 100 mol % of isophthalic acid; and

c) ii) from 60 to 0 mol % of at least one further aliphatic, cycloaliphatic or aromatic dicarboxylic or polycarboxylic acid; and

d) i) from 80 to 100 mol % of at least one linear, aliphatic or cycloaliphatic diol; and

d) ii) from 20 to 0 mol % of at least one branched, aliphatic or cycloaliphatic polyol; and

C) from 5 to 30% by weight of at least one isocyanate component containing urethane groups or urethane groups and isocyanurate groups and blocked partly or totally with a blocking agent; and

D) if desired, auxiliaries and adjuvants, and also the coated metal strips themselves.

The ready-to-spray powder may be applied to appropriate substrates by the known methods, examples including electrostatic powder spraying, fluidized bed sintering and electrostatic fluidized bed sintering. Following powder application, the coated workpieces are cured conventionally by heating at a temperature from 160 to 250° C. for from 60 minutes to 30 seconds, preferably at from 170 to 240° C. for from 30 minutes to 1 minute, in an oven. The temperature includes all values and subvalues therebetween, especially including 170, 180, 190, 200, 210, 220, 230 and 240° C. When a coil coating oven is used, the curing conditions are commonly temperatures from 200 to 350° C. for from 90 to 10 seconds. The temperature when using a coil coating oven includes all values and subvalues therebetween, especially including 210, 220, 230, 240, 250, 260, 270, 280, 290, 300, 310, 320, 330 and 340° C.

In order to raise the gelling rate of the heat-curable powder coating materials, catalysts may be added. Examples of catalysts used include organotin compounds such as dibutyltin dilaurate, tin(II) octoate, dibutyltin maleate or butyltin tris(2-ethylhexanoate) or amines such as diazabicyclononane or diazabicycloundecene. The amount of added catalyst is from 0.01 to 1.0% by weight, based on the total amount of powder coating material. The amount of catalyst includes all values and subvalues therebetween, especially including 0.05, 0.1, 0.2, 0.3, 0.4, 0.5, 0.6, 0.7, 0.8 and 0.9% by weight.

The subject matter of the invention is illustrated below with reference to examples.

### EXAMPLES

A) (Semi)Crystalline Polyesters

### Example 1

The polyester had the following composition: as acid component: 100 mol % dodecanedioic acid; as alcohol component: 100 mol % monoethylene glycol. The polyester had an OH number of 31 mg KOH/g, an acid number of 0.5 mg KOH/g and a melting point of 85° C.

### Example 2

The polyester had the following composition: as acid component: 100 mol % adipic acid; as alcohol component: 100 mol % hexane-1,6-diol. The polyester had an OH number of 29 mg KOH/g, an acid number of 1.0 mg KOH/g and a melting point of 55° C.

B) Amorphous Polyesters

### Example 1

The polyester had the following composition: as acid component: 100 mol % dimethyl isophthalate; as alcohol components: 96 mol % neopentyl glycol and 4 mol % trimethylolpropane. The polyester had an OH number of 25 mg KOH/g, an acid number of 2.2 mg KOH/g and a glass transition temperature of 54° C.

### Example 2

The polyester had the following composition: as acid components: 80 mol % dimethyl isophthalate, 20 mol % hexahydroterephthalate; as alcohol components: 20 mol % monoethylene glycol, 40 mol % neopentyl glycol and 40 mol % cyclohexanedimethanol. The polyester had an OH number of 20 mg KOH/g, an acid number of 0.3 mg KOH/g and a glass transition temperature of 52° C.

C) Preparation of Blocked Isocyanate Components

### Example 1

699.8 g of Desmodur N 3300 (polyisocyanato isocyanurate based on hexamethylene diisocyanate, from Bayer) and 1 632.8 g of VESTANAT T 1890 (polyisocyanato isocyanurate based on isophorone diisocyanate, from Degussa) were heated to 100° C. 3.5 g of dibutyltin dilaurate were added. Then 1 163.9 g of ε-caprolactam were added in portions. An hour following the final portion of ε-caprolactam, the reaction was at an end. The reaction mixture was then cooled to room temperature. The reaction product had a free NCO group content of 0.4%, a total NCO group content of 12.0% and a melting range of 88-91° C.

### Example 2

488.4 g of isophorone diisocyanate were heated to 110° C. with stirring and 68.3 g of monoethylene glycol were metered in. After a reaction time of 60 minutes, 249.1 g of ε-caprolactam were added. After a further 60 minutes, the product was cooled and comminuted. The reaction product had a free NCO group content of 0.2%, a blocked NCO group content of 11.4% and a melting range of 65-75° C.

D) Polyurethane Powder Coating Materials

General Preparation Instructions

The comminuted products—blocked polyisocyanate (crosslinker), polyester, leveling agent, devolatilizer and catalyst masterbatch—are intimately mixed with the white pigment in an edge runner mill and the mixture is then homogenized in an extruder at not more than 130° C. After cooling, the extrudate is fractionated and ground to a particle size <100 μm using a pin mill. The powder prepared in this way is applied to degreased, iron-phosphated steel panels using an electrostatic powder spraying unit at 60 kV, and the panels are baked in a coil coating oven.

The formulations contained 30% by weight Kronos 2160 (titanium dioxide from Kronos), 1% by weight Resiflow PV 88 (leveling agent from Worlée-Chemie), 0.5% by weight benzoin (devolatilizer from Merck-Schuchard) and 0.1% by weight dibutyltin dilaurate (catalyst from Crompton Vinyl Additives GmbH). The OH/NCO ratio was 1:1.

Table 1
Data of white-pigmented PU powder coil coating materials

| | | | | |
|---|---|---|---|---|
| Polyester A) | 11.76 g A) 1 | — | 17.86 g | — |
| | | | A)2 | |
| Polyester B) | 47.03 g B) 1 | 59.17 g B) 1 | 41.67 g | 60.46 g B) 2 |
| | | | B)2 | |
| Isocyanate C) | 9.61 g C) 1 | 9.23 g C) 1 | 8.87 g | 7.94 g C) 2 |
| | | | C) 2 | |
| Baking | 241° C./70 sec | 241° C./ | 241° C./ | 241° C./ |
| conditions | | 70 sec | 70 sec | 70 sec |
| Film thickness | 56-70 | 31-44 | 58-65 | 35-59 |
| (μm) | | | | |
| Gloss | 91 | 90 | 87 | 81 |
| 60° angle | | | | |
| Indentation | >10 | >10 | >10 | 7 |
| (mm) | | | | |
| BI dir./indir. | >160/>160 | 80/20 | >160/ | 40/<10 |
| (inch lb) | | | >160 | |
| T bend | 0T | 1T | 0T | >2T |
| Note | | Compara- | | Compara- |
| | | tive | | tive |

The abbreviations in the Table have the following meanings:

| | |
|---|---|
| Gloss 60° angle | = measurement of the Gardner gloss (ASTM-D 5233) |
| Indentation | = Erichsen indentation (DIN 53 156) |
| BI dir./indir. | = direct and indirect ball impact (ASTM D 2794-93) |
| T bend | = deformation test (ECCA T 7) |

German patent application 10159488.7, filed Dec. 4, 2001, is incorporated herein by reference.

Numerous modifications and variations on the present invention are possible in light of the above teachings. It is therefore to be understood that within the scope of the appended claims, the invention may be practiced otherwise than as specifically described herein.

1. A polyurethane powder coating composition, comprising:
A) from 5 to 80% by weight of at least one (semi)crystalline polyester having a hydroxyl number of from 5 to 100 mg KOH/g, a melting point from 50 to 130° C. and a glass transition temperature of <−10° C.;
wherein said (semi)crystalline polyester comprises
a) i) from 85 to 100 mol % of succinic acid; or
a) ii) from 85 to 100 mol % of adipic acid; or
a) iii) from 85 to 100 mol % of sebacic acid; or
a) iv) from 85 to 100 mol % of dodecanedioic acid; and
a) v) from 15 to 0 mol % of at least one second aliphatic, cycloaliphatic or aromatic dicarboxylic acid; and
b) i) from 80 to 100 mol % of monoethylene glycol; or
b) ii) from 80 to 100 mol % of butane-1,4-diol; or
b) iii) from 80 to 100 mol % of hexane-1,6-diol; and
b) iv) from 20 to 0 mol % of at least one further aliphatic or cycloaliphatic, linear or branched polyol; and
B) from 10 to 80% by weight of at least one amorphous polyester having a hydroxyl number of from 15 to 200 mg KOH/g, a melting point from ≧70° C. to ≦120° C., and a glass transition temperature of >40° C.;
wherein said amorphous polyester comprises
c) i) from 40 to 100 mol % of isophthalic acid; and
c) ii) from 60 to 0 mol % of at least one further aliphatic, cycloaliphatic or aromatic dicarboxylic or polycarboxylic acid; and
d) i) from 80 to 100 mol % of at least one linear, aliphatic or cycloaliphatic diol; and
d) ii) from 20 to 0 mol % of at least one branched, aliphatic or cycloaliphatic polyol; and
C) from 5 to 30% by weight of at least one isocyanate component comprising a) an urethane group or b) an urethane group and an isocyanurate group;
wherein said isocyanate component is partly or totally blocked with a blocking agent.

2. The composition according to claim 1, further comprising D) an auxiliary, an adjuvant or both.

3. The composition as claimed in claim 1, wherein the (semi)crystalline polyester A) comprises a compound selected from the group consisting of glutaric acid, azelaic acid, 1,4-cyclohexane-dicarboxylic acid, 1,3-cyclohexane-dicarboxylic acid or 1,2-cyclohexanedicarboxylic acid, terephthalic acid, isophthalic acid and mixtures thereof.

4. The composition as claimed in claim 1, wherein the (semi)crystalline polyester A) comprises a compound selected from the group consisting of diethylene glycol, neopentyl glycol hydroxypivalate, neopentyl glycol, cyclohexanedimethanol, pentane-1,5-diol, pentane-1,2-diol, nonane-1,9-diol, trimethylolpropane, glycerol, pentaerythritol and mixtures thereof.

5. The composition as claimed in claim 1, wherein the amorphous polyester B) comprises a compound selected from the group consisting of phthalic acid, adipic acid, azelaic acid, sebacic acid, dodecanedioic acid, trimellitic acid, hexahydroterephthalic acid, hexahydrophthalic acid, succinic acid, 1,4-cyclohexanedicarboxylic acid and mixtures thereof.

6. The composition as claimed in claim 1, wherein the amorphous polyester B) comprises a compound selected from the group consisting of monoethylene glycol, diethylene glycol, neopentyl glycol hydroxypivalate, neopentyl glycol, cyclohexanedimethanol, butane-1,4-diol, pentane-1,5-diol, pentane-1,2-diol, hexane-1,6-diol, nonane-1,9-diol and mixtures thereof.

7. The composition as claimed in claim 1, wherein the amorphous polyester B) comprises a compound selected from the group consisting of trimethylolpropane, glycerol, pentaerythritol and mixtures thereof.

8. The composition as claimed in claim 1, wherein said isocyanate component C) comprises diisocyanate of aliphatic and (cyclo)aliphatic and/or cycloaliphatic structure.

9. The composition as claimed in claim 1, wherein said isocyanate component C) comprises hexamethylene diisocyanate, 2-methylpentamethylene 1,5-diisocyanate, 2-ethyltetramethylene 1,4-diisocyanate, 2,2,4 (2,4,4)-trimethylhexamethylene 1,6-diisocyanate, isophorone diisocyanate, 4,4′-diisocyanatodicyclohexylmethane, norbornane diisocyanate or mixtures thereof.

10. The composition as claimed in claim 1, wherein said isocyanate component C) comprises a compound selected from the group consisting of ethylene glycol, propane-1,3-diol, butane-1,4-diol, pentane-1,5-diol, 3-methylpentane-1,5-diol, hexane-1,6-diol, 2,2,4 (2,4,4)-trimethylhexane-1,6-diol, 1,4-di(hydroxymethyl)cyclohexane, diethylene glycol, triethylene glycol, diethanolmethylamine, neopentyl glycol, triethanolamine, trimethylolpropane, trimethylolethane, glycerol, pentaerythritol and mixtures thereof.

11. The composition as claimed in claim 1, wherein at least 2 and not more than 8 equivalents of NCO in the diisocyanate are reacted per OH equivalent of the polyol for preparing the isocyanate component C).

12. The composition as claimed in claim 1, wherein said isocyanate component C) comprises a compound selected from the group consisting of a trimer of hexamethylene diisocyanate, 2-methylpentamethylene 1,5-diisocyanate, 2-ethyltetramethylene 1,4-diisocyanate, trimethylhexamethylene 1,6-diisocyanate, isophorone diisocyanate, 4,4′-diisocyanatodicyclohexylmethane, norbornane diisocyanate and a mixture thereof.

13. The composition as claimed in claim 1, wherein said blocking agent in isocyanate component C) is a compound selected from the group consisting of phenol, p-chlorophenol, benzyl alcohol, acetone oxime, methyl ethyl ketoxime, cyclopentanone oxime, cyclohexanone oxime, methyl isobutyl ketoxime, methyl tert-butyl ketoxime, diisopropyl ketoxime, diisobutyl ketoxime, acetophenone oxime, N-hydroxysuccinimide, hydroxypyridines, ε-caprolactam, ethyl acetoacetate, malonates, diisopropylamine, 3,5-dimethylpyrazole, 1,2,4-triazole, glycolates, benzyl methacrylohydroxamate, methyl p-hydroxybenzoate and mixtures thereof.

14. The composition as claimed in claim 1, wherein the isocyanate component C) has an NCO content of from 8 to 20% by weight.

15. The composition as claimed in claim 1, wherein the isocyanate component C) is blocked such that there are 0.5-1.1 mol of blocking agent per equivalent of isocyanate.

16. The composition as claimed in claim 1, wherein the proportion in which (semi)crystalline polyester A), amorphous polyester B), and blocked isocyanate component C) are mixed is chosen so that there are from 0.6 to 1.2 blocked NCO groups per OH group.

17. The composition as claimed in claim 1, wherein an OH/NCO ratio is 1:0.8 to 1.1.

18. The composition as claimed in claim 1, wherein an OH/NCO ratio is 1:1.

19. The composition as claimed in claim 1, further comprising a catalyst in a concentration of from 0.01 to 1.0% by weight, based on a weight of the total powder coating composition.

20. The composition as claimed in claim 19, comprising an organotin compound and/or an amine in a concentration of from 0.01 to 1.0% by weight, based on the weight of the total powder coating composition.

21. The composition as claimed in claim 1, further comprising a catalyst, a pigment, a filler, a dye, a leveling agent, a light stabilizer, a heat stabilizer, an antioxidant, a gloss enhancer or an effect additive as component D).

22. A process for preparing the polyurethane powder coating composition according to claim 1, comprising:
mixing components A)-C) in a heatable apparatus at an upper temperature limit of between 130 and 140° C.

23. The process according to claim 22, further comprising:
adding D) an auxiliary, an adjuvant or both.

24. The process as claimed in claim 22, wherein said heatable apparatus is a heatable compounder or a heatable extruder.

25. A process for coating a metal strip, comprising:
coating a metal strip in a coil coating process with the composition according to claim 1.

26. A coated metal strip obtained by the process of claim 25.
